(19) United States
(12) Patent Application Publication
(10) Pub. No.: US 2015/0103262 A1
(43) Pub. Date: Apr. 16, 2015

(54) TOUCHSCREEN PANEL AND MANUFACTURING METHOD THEREOF

(71) Applicant: SAMSUNG ELECTRO-MECHANICS CO., LTD., Suwon (KR)

(72) Inventor: In Taek SONG, Suwon (KR)

(73) Assignee: SAMSUNG ELECTRO-MECHANICS CO., LTD., Suwon (KR)

(21) Appl. No.: 14/143,573

(22) Filed: Dec. 30, 2013

(30) Foreign Application Priority Data
Oct. 15, 2013 (KR) 10-2013-0122628

(51) Int. Cl. G06F 3/0354; B32B 38/00; B32B 37/06; B32B 37/12; B32B 37/18

(52) U.S. Cl. CPC G06F 3/03547; B32B 37/12; B32B 37/18; B32B 37/06; B32B 38/0008; B32B 2457/208
USPC 349/12; 156/73.1; 156/60

(57) ABSTRACT

There are provided a touchscreen panel and a manufacturing method thereof, and more particularly, a touchscreen panel having excellent moisture resistance properties, and a manufacturing method thereof. The touchscreen panel may be manufactured by a manufacturing method including: a first step of providing a touch module in which a first substrate, a touch sensing portion, and a second optical clear adhesive are sequentially laminated; and a second step of forming a sealing part by supersonic-fusion or heat-fusion between edges of the second optical clear adhesive and the first substrate via a protective film remaining at an edge of the second optical clear adhesive.

### CROSS-REFERENCE TO RELATED APPLICATION

This application claims the benefit of Korean Patent Application No. 10-2013-0122628 filed on Oct. 15, 2013, with the Korean Intellectual Property Office, the disclosure of which is incorporated herein by reference.

### BACKGROUND

The present disclosure relates to a touchscreen panel and a manufacturing method thereof, and more particularly, to a touchscreen panel having excellent moisture resistance properties, and a manufacturing method thereof.

A touch sensing apparatus such as a touchscreen, a touchpad, or the like, an input apparatus attached to a display apparatus to provide an intuitive data input method to a user, has recently been widely used in various electronic devices such as cellular phones, personal digital assistants (PDA), navigation devices, and the like. Particularly, as demand for smartphones has recently increased, the use of a touchscreen as a touch sensing apparatus capable of providing various input methods in a limited form factor has increasingly increased.

Touchscreens used in portable devices may mainly be divided into resistive type touchscreens, capacitive type touchscreens, infrared (IR) type touchscreens, and the like, according to a method of sensing a touch used therein. Among them, the capacitive type touchscreen has advantages in that it has a relatively long lifespan and may easily implement various input methods and gesture, such that the use thereof has increasingly increased. Particularly, the capacitive type touchscreen may more easily implement a multi-touch interface as compared with the resistive type touchscreen, such that it is widely used in devices such as smartphones, and the like.

The capacitive type touchscreen includes a plurality of electrodes having a predetermined pattern. In this capacitive type touchscreen, electrodes should be formed at most of the touchscreen region corresponding to an effective display region of the display apparatus and the plurality of electrodes should have a predetermined pattern in order to sense a touch.

A transparent electrode of the capacitive type touchscreen, most prevalently used according to the related art, may be formed of an indium tin oxide (hereinafter, referred to as ITO) electrode. However, there may be disadvantages in using the ITO electrode, as described below.

First, due to limited indium reserves and rapidly increasing demand therefor around the world, it is difficult to smoothly supply an ITO electrode material itself, and thus, exhaustion of indium resources and an increase in the cost thereof due to the scarcity thereof are expected.

Second, sheet resistance (˜several hundreds of ohms/sq) of such an ITO electrode may be relatively high as compared to sheet resistance (less than 1 ohm/sq) of an electrode using a thin film formed of a metal such as Cu or Ni, such that power consumption may be increased, and as in a portable device, a fine touch resolution has gradually become required, an electrode pattern has been reduced in thickness, and resistance has increased, which becomes a limitation in using the ITO electrode.

Third, the ITO electrode has a main feature in which electrical conductivity and optical transparency are combined with each other, such that in the case of thickening a thin film, since metal conductivity is increased but optical transparency is decreased, a thin film (<100 nm) should be applied. However, as an expensive laser etching apparatus was previously used as an etching method in order to perform the uniform patterning on this thin film, manufacturing costs thereof may be increased.

In order to produce a touchscreen capable of overcoming the above-mentioned limitations, the development of a manufacturing method for a transparent electrode having low sheet resistance by forming a mesh pattern having a fine line-width using a thin film of a metal such as copper (Cu), nickel (Ni), or the like has been conducted. While the metal is basically opaque, the line-width of the mesh pattern is narrow enough to be to be optically invisible.

Here, in the case of copper (Cu), there are advantages such as excellent electric conductivity and economical efficiency, but there is a problem in that the copper electrode may be vulnerable to corrosion due to the infiltration of moisture, or the like, as compared to the ITO electrode.

FIG. 1 is a cross-sectional view of a touchscreen panel according to the related art. Referring to FIG. 1, a touch module in which a first substrate 1, a touch sensing portion 2, and a second substrate 3 are sequentially laminated may be protected from moisture, or the like, by a sealing part 4 provided at aside portion thereof. However, since the sealing part 4 has a structure in which a thickness thereof is decreased from a lower portion toward an upper portion, the upper portion may be vulnerable to the infiltration of moisture.

In addition, the sealing part is generally formed by applying an adhesive, but it may not be easy to apply the adhesive, and a curing time thereof may be relatively long, such that productivity may be decreased. Further, a portion in which sealing is incomplete may be generated according to an application amount and application method of the adhesive, such that infiltration of water/foreign materials may not be completely blocked.

### SUMMARY

An aspect of the present disclosure may provide a touchscreen panel capable of increasing bonding strength of a sealing part provided on a side portion of a touch module.

An aspect of the present disclosure may also provide a manufacturing method of a touchscreen panel capable of simply forming a sealing part while increasing bonding strength.

According an aspect of the present disclosure, a touchscreen panel may include: a touch module in which a first substrate, a touch sensing portion, and a second optical clear adhesive are sequentially laminated; and a sealing part provided between edges of the first substrate and the second optical clear adhesive to seal an edge of the touch sensing portion.

A first optical clear adhesive may be interposed between the first substrate and the touch sensing portion.

The first substrate and the second optical clear adhesive may be provided so as to have areas larger than those of the touch sensing portion and the first optical clear adhesive to thereby protrude outwardly of edges of the touch sensing portion and the first optical clear adhesive.

The touch module may further include a second substrate provided on a surface opposite to a surface of the second optical clear adhesive on which the touch sensing portion is provided.

The first and second optical clear adhesives may be transparent.

The sealing part may be formed of a plastic material, and the plastic material may have a random recrystallized structure.

The touch sensing portion may be provided integrally with the first substrate.

According to another aspect of the present disclosure, in a manufacturing method of a touchscreen panel, the manufacturing method may include: a first step of providing a touch module in which a first substrate, a touch sensing portion, and a second optical clear adhesive are sequentially laminated; and a second step of forming a sealing part by supersonic-fusion or heat-fusion between edges of the second optical clear adhesive and the first substrate via a protective film remaining at an edge of the second optical clear adhesive.

In a process of adhering the second optical clear adhesive to the touch sensing portion, the first step may include a 1-2nd step of retaining protective film on a portion of the second optical clear adhesive protruding outwardly of an edge of the touch sensing portion and only removing the protective film from a portion of the second optical clear adhesive overlapped with the touch sensing portion in a lamination direction.

The first step may include a step of interposing a first optical clear adhesive between the first substrate and the touch sensing portion.

The first substrate and the second optical clear adhesive may be provided so as to have areas larger than those of the touch sensing portion and the first optical clear adhesive to thereby protrude outwardly of edges of the touch sensing portion and the first optical clear adhesive.

The manufacturing method may further include a third step of additionally laminating a second substrate on a surface thereof opposite to a surface of the second optical clear adhesive on which the touch sensing portion is provided.

The sealing part may be formed of a plastic material, and a structure of the plastic material may be deformed from a molecular oriented crystalline structure into a random recrystallized structure by the supersonic-fusion or heat-fusion.

The touch sensing portion may be provided integrally with the first substrate.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view of a touchscreen panel according to the related art;

FIG. 2 is a cross-sectional view of a touchscreen panel according to an exemplary embodiment of the present disclosure;

FIG. 3 is a cross-sectional view showing a structure of an optical clear adhesive used in an exemplary embodiment of the present disclosure before being processed;

FIG. 4 is a cross-sectional view showing a structure processed in order to use an optical clear adhesive used in an exemplary embodiment of the present disclosure; and

FIGS. 5A through 5C are cross-sectional views showing a manufacturing process of a touchscreen panel according to an exemplary embodiment of the present disclosure.

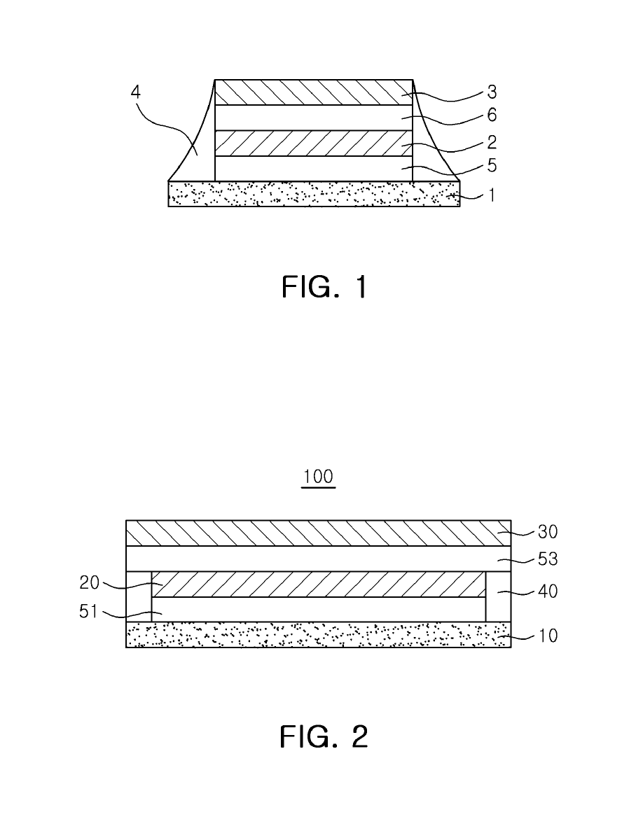

### DETAILED DESCRIPTION

Exemplary embodiments of the present disclosure will now be described in detail with reference to the accompanying drawings.

FIG. 2 is a cross-sectional view of a touchscreen panel according to an exemplary embodiment of the present disclosure.

Referring to FIG. 2, the touchscreen panel 100 according to an exemplary embodiment of the present disclosure may include a touch module in which a first substrate 10, a touch sensing portion 20, and a second optical clear adhesive 53 are sequentially laminated and a sealing part 40 provided between edges of the first substrate 10 and the second optical clear adhesive 53 and sealing an edge of the touch sensing portion. Here, a first optical clear adhesive 51 may be interposed between the first substrate 10 and the touch sensing portion 20 to adhere the first substrate 10 and the touch sensing portion 20 to each other.

Here, the touch module may further include a second substrate 30 provided on a surface opposite to a surface of the second optical clear adhesive 53 on which the touch sensing portion 20 is provided.

In the present specification, the terms such as top, bottom, upper portion, lower portion, upper side, lower side, left, right, left side, right side, side surface, and the like, are used based on the views shown in the accompanying drawings, and when a direction of the corresponding object is changed, the terms may be differently used.

The first and second substrates 10 and 30 may be a transparent substrate and be formed of a plastic material such as polyimide (PI), polymethylmethacrylate (PMMA), polyethyleneterephthalate (PET), or polycarbonate (PC), or tempered glass. In addition, with respect to a region in which wiring connecting a plurality of first electrodes (not shown) and a plurality of second electrodes (not shown) to each other is provided except for regions at which the plurality of first electrodes (not shown) and the plurality of second electrodes (not shown) provided in the touch sensor 20 are formed, a predetermined printing region for visually shielding the wiring formed of generally an opaque metal material may be formed on the substrate.

In addition, the first substrate may be provided so as to have an area larger than those of the touch sensing portion 20 and the first optical clear adhesive 51 to thereby protrude outwardly of the edges of the touch sensing portion 20 and the first optical clear adhesive 51.

Although described below, since the sealing part 40 may be provided between the edges of the first substrate 10 and the second optical clear adhesive 53 and seal the edge of the touch sensing portion 20, an edge portion of the first substrate 10 needs to protrude outwardly of the touch sensing portion 20 and the first optical clear adhesive 51.

The touch sensing portion 20 may be a patterned metal mesh electrode formed by intersecting the first electrode (not shown) and the second electrode (not shown) with each other on the substrate. The metal mesh electrode (not shown) may be formed of one of copper (Cu), nickel (Ni), aluminum (Al), and the like, which are a metal material except for indium tin oxide (ITO), or an alloy thereof. The substrate may be a printed circuit board or a flexible printed circuit board (FPCB). Here, the touch sensing portion 20 may be first and second electrodes patterned on the first substrate 10 as well as first and second electrodes patterned on a separate substrate. That is, the touch sensing portion 20 may be provided integrally with the first substrate 10.

The metal mesh electrode may have a line-width of 5 to 20 μm. In the case in which the line-width is less than 5 μm, a defect rate of the touchscreen panel may be increased, and in the case in which the line-width is more than 20 μm, the metal mesh electrode may be recognized by the naked eye. In addition, an interval between the plurality of first electrodes (not shown) or an interval between the plurality of second electrodes (not shown) may be 200 μm or more. In the case in which the interval is less than 200 μm, transmittance may be decreased.

Meanwhile, since the metal mesh electrode may be formed of one of copper (Cu), nickel (Ni), aluminum (Al), and the like, or an alloy thereof, there is a disadvantage in that the metal mesh electrode may be vulnerable to corrosion due to moisture, or the like.

In addition, although not shown in FIG. 2, each of the plurality of first and second electrodes (not shown) may be electrically connected to a wiring pattern of a circuit board attached to one end of the substrate through wirings and a bonding pad. The circuit board may be mounted with a controller integrated circuit to detect sensing signals generated in the plurality of first and second electrodes and judge touches from the sensing signals.

In addition, the touch sensing portion 20 may have an area smaller than that of the first substrate 10, such that the edge thereof needs to be positioned inwardly of the edge of the first substrate 10.

Although described below, since the sealing part 40 may be provided between the edges of the first substrate 10 and the second optical clear adhesive 53 and seal the edge of the touch sensing portion 20, the edge portion of the touch sensing portion 20 needs to be positioned inwardly of the first substrate 10.

The first and second optical clear adhesives (OCA) 51 and 53 may be interposed between the first substrate 10 and the touch sensing portion 20 and between the touch sensing portion 20 and the second substrate 30, respectively, to thereby adhere upper and lower substrates to each other. The first and second optical clear adhesives 51 and 53 may be transparent and formed of an insulating material to thereby electrically insulating the upper and lower substrates from each other.

Meanwhile, the touch sensing portion 20 may be formed integrally with the first substrate 10. In addition, a separate adhesive may not be interposed between the first substrate 10 and the touch sensing portion 20.

Here, the second optical clear adhesive 53 may be provided so as to have an area larger than those of the touch sensing portion 20 and the first optical clear adhesive 51 to thereby protrude outwardly of the edges of the touch sensing portion 20 and the first optical clear adhesive 51.

Although described below, since the sealing part 40 may be provided between the edges of the first substrate 10 and the second optical clear adhesive 53 and seal the edge of the touch sensing portion 20, an edge portion of the first substrate 10 needs to protrude outwardly of the touch sensing portion 20 and the first optical clear adhesive 51.

The sealing part 40 may be provided at a side portion of the touch module. The sealing part 40 may be provided along sides of the touch sensing portion 20 and the first optical clear adhesive 51 in a lamination direction so as to seal the sides of the touch sensing portion 20 and the first optical clear adhesive 51. That is, the sealing part 40 may have a uniform thickness from an upper portion thereof toward a lower portion thereof.

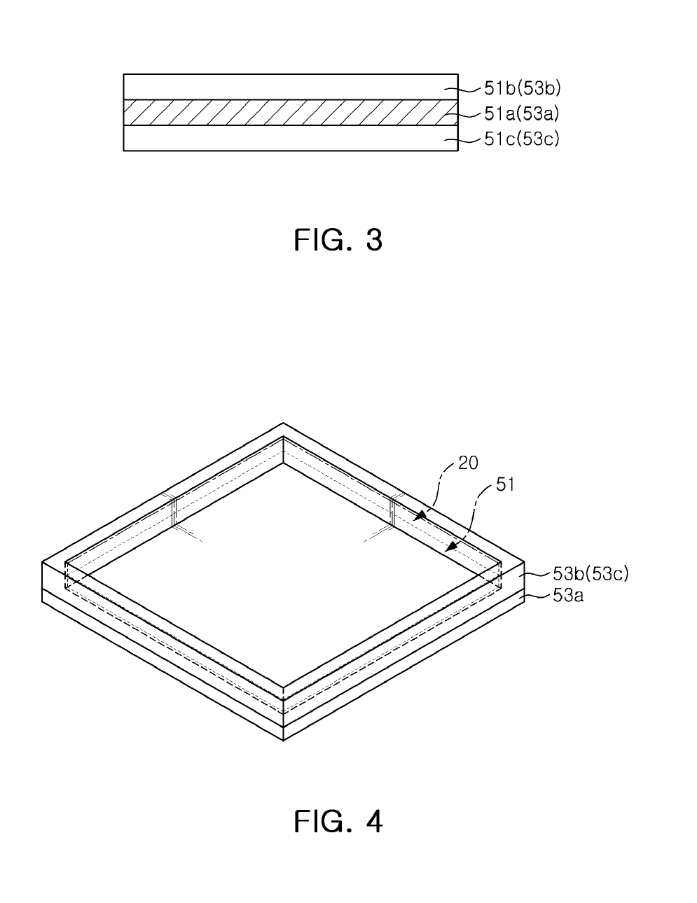

The sealing part 40 may be formed using a protective film 53b remaining during a process of attaching the second optical clear adhesive 53 to the touch sensing portion 20. A detailed description thereof will be provided with reference to FIGS. 3 and 4.

FIG. 3 is a cross-sectional view showing a structure of an optical clear adhesive used in an exemplary embodiment of the present disclosure before being processed, and FIG. 4 is a cross-sectional view showing a structure processed in order to use an optical clear adhesive used in an exemplary embodiment of the present disclosure.

Referring to FIG. 3, the first and second optical clear adhesives 51 and 53 according to an exemplary embodiment of the present disclosure may include adhesive tapes 51a and 53a and protective films 51b and 51c, and 53b and 53c provided on both surfaces thereof so as to protect adhesive force of the adhesive tapes 51a and 53a, respectively.

The first and second optical clear adhesives 51 and 53, which are to basically adhere two media to each other, may be interposed between the two media during a process of adhering two media to each other by removing the protective films 51b and 51c, and 53b and 53c provided on both surfaces of the adhesive tapes 51a and 53a and then utilizing the adhesive tapes 51a and 53a as a double-sided tape, respectively, to thereby adhere the two media to each other. Of course, after removing only protective films on any one surface of the adhesive tapes 51a and 53a among the protective films, the first and second optical clear adhesive 51 and 53 may be adhered to a surface of a predetermined medium.

Referring to FIG. 4, the structure used in a process of adhering the second optical clear adhesive 53 according to an exemplary embodiment of the present disclosure to one surface of the touch sensing portion 20 is disclosed.

The second optical clear adhesive 53 shown in FIG. 4 may include the adhesive tape 53a and the protective films 53b or 53c provided on one surface along an edge portion of the adhesive tape 53a. As the protective film 53b or 53c, the protective film 53b or 53c on any one of both surfaces based on the adhesive tape 53a may be used. Here, a central portion of the protective film 53b or 53c except for the edge portion of the adhesive tape 53a, that is, a portion of the protective film to which the touch sensing portion 20 is adhered, may be removed. Therefore, the second optical clear adhesive 53 may be adhered to the touch sensing portion 20.

In addition, the protective film 53b or 53c provided at the edge portion of the adhesive tape 53a may be used to form the sealing part 40.

That is, as described above, the touch sensing portion 20 and the first optical clear adhesive 51 may be interposed between the first substrate 10 and the second optical clear adhesive 53, and the side portions thereof may be sealed by the sealing part 40.

Therefore, in this exemplary embodiment, the protective film 53b or 53c at the edge portion except for the portion to which the touch sensing portion 20 is directly adhered in the surface of the second optical clear adhesive 53 adhered to the touch sensing portion 20 may remain. In addition, the sealing part 40 may be formed by supersonic-fusion or heat-fusion between the edge of the first substrate 10 and the edge of the second optical clear adhesive 53 via the protective film 53b or 53c remaining at the edge of the second optical clear adhesive 53.

Here, the protective film 53b or 53c may be formed of a plastic (for example, PET) material, and a structure of this plastic material may be deformed from a molecular oriented crystalline structure into a random recrystallized structure by supersonic-fusion or heat-fusion, thereby forming the sealing part 40 having an excellent moisture proof effect.

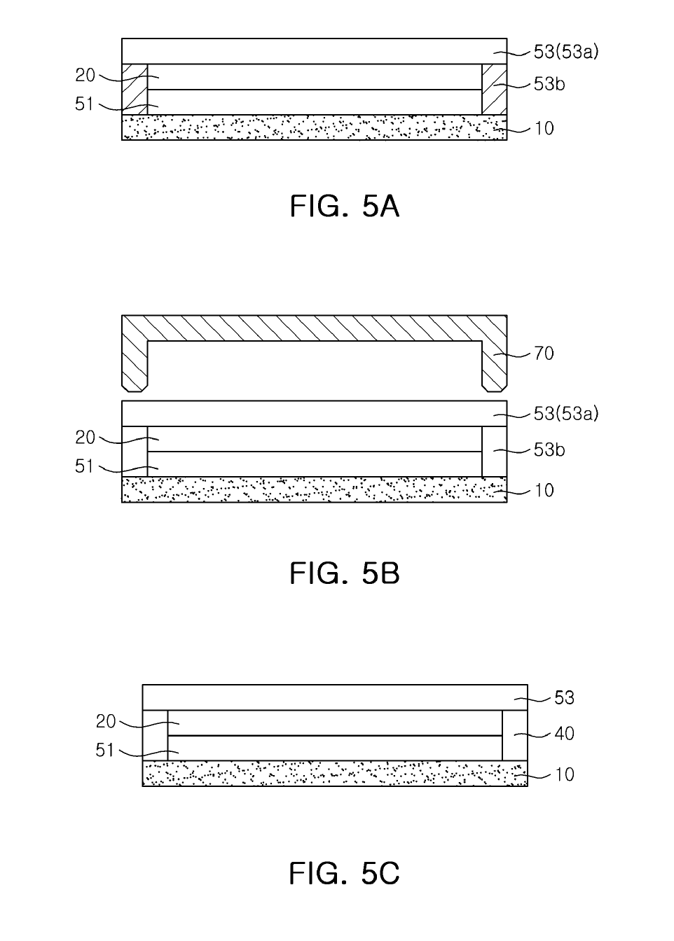

FIGS. 5A through 5C are cross-sectional views showing a manufacturing process of a touchscreen panel according to an exemplary embodiment of the present disclosure.

Referring to FIGS. 5A through 5C, the manufacturing method according to an exemplary embodiment of the present disclosure may include: a first step of providing a touch module in which a first substrate 10, a touch sensing portion 20, and a second optical clear adhesive 53 are sequentially laminated; and a second step of forming a sealing part 40 by supersonic-fusion or heat-fusion between edges of the second optical clear adhesive 53 and the first substrate 10 via the protective film 53b or 53c remaining at the edge of the second optical clear adhesive 53. Here, a first optical clear adhesive 51 may be interposed between the first substrate 10 and the touch sensing portion 20 to adhere the first substrate 10 and the touch sensing portion 20 to each other.

Hereinafter, a description of a structure and configuration of the touchscreen panel 100 will be replaced with the detailed description provided with reference to FIG. 2, and the manufacturing method of a touchscreen panel will be described in detail.

Referring to FIG. 5A, the first step of the manufacturing method of a touchscreen panel according to an exemplary embodiment of the present disclosure is a step of providing the touch module in which the first substrate 10, the touch sensing portion 20, and the second optical clear adhesive 53 are sequentially laminated. Here, the first substrate 10 and the second optical clear adhesive 53 may be provided so as to have areas larger than those of the touch sensing portion 20 and the first optical clear adhesive 51 to thereby protrude outwardly of the edges of the touch sensing portion 20 and the first optical clear adhesive 51.

In addition, the touch sensing portion 20 may be first and second electrodes patterned on the first substrate 10 as well as first and second electrodes patterned on a separate substrate. That is, the touch sensing portion 20 may be provided integrally with the first substrate 10.

Here, in a process of adhering the second optical clear adhesive 53 to the touch sensing portion 20, the first step may include a 1-2nd step of leaving a protective film 53b or 53c at a portion of the second optical clear adhesive 53 protruding outwardly of an edge of the touch sensing portion and removing only the protective film 53b or 53c at a portion of the second optical clear adhesive 53 overlapped with the touch sensing portion 20 in a lamination direction. Of course, in this case, the first optical clear adhesive 51 may be provided so as to have a size approximately equal to that of the touch sensing portion 20 to thereby be overlapped with the touch sensing portion 20 in the lamination direction.

Therefore, in the second optical clear adhesive 53, the protective film 53b or 53c that is not removed along the edge portion of the portion on which the touch sensing portion 20 is provided in the lamination direction may remain.

Next, referring to FIG. 5B, in the second step of the manufacturing method of a touchscreen panel according to an exemplary embodiment of the present disclosure, the sealing part may be formed by supersonic-fusion or heat-fusion between the edges of the second optical clear adhesive 53 and the first substrate 10 via the protective film 53b or 53c remaining at the edge of the second optical clear adhesive 53. The sealing part may be formed along portions of the protective film 53b or 53c remaining at the edge of the second optical clear adhesive 53 using a supersonic-fusion tip or a heat-fusion tip 70 in an outer side direction of the second optical clear adhesive 53.

Of course, in the case in which a second substrate 30 is firstly adhered to a rear surface of the second optical clear adhesive 53, the sealing part may be formed along the portion of the protective film 53b or 53c remaining at the edge of the second optical clear adhesive 53 using a supersonic-fusion tip or a heat-fusion tip 70 in an outer side direction of the second substrate 30.

Then, referring to FIG. 5C, the touchscreen panel 100 including the sealing part 40 formed by supersonic-fusion or heat-fusion may be completed. As described above, the sealing part 40 may be formed between the edges of the second optical clear adhesive 53 and the first substrate 10 to thereby seal the sides of the touch sensing portion 20 and the first optical clear adhesive 51.

As set forth above, according to exemplary embodiments of the present disclosure, the touchscreen panel capable of increasing bonding strength of the sealing part provided at the side portion of the touch module may be provided.

In addition, the manufacturing method of a touchscreen panel capable of simply forming the sealing part while increasing bonding strength may be provided.

While exemplary embodiments have been shown and described above, it will be apparent to those skilled in the art that modifications and variations could be made without departing from the spirit and scope of the present disclosure as defined by the appended claims.

What is claimed is:

1. A touchscreen panel comprising:
a touch module in which a first substrate, a touch sensing portion, and a second optical clear adhesive are sequentially laminated; and
a sealing part provided between edges of the first substrate and the second optical clear adhesive to seal an edge of the touch sensing portion.

2. The touchscreen panel of claim 1, wherein a first optical clear adhesive is interposed between the first substrate and the touch sensing portion.

3. The touchscreen panel of claim 2, wherein the first substrate and the second optical clear adhesive are provided so as to have areas larger than those of the touch sensing portion and the first optical clear adhesive to thereby protrude outwardly of edges of the touch sensing portion and the first optical clear adhesive.

4. The touchscreen panel of claim 1, wherein the touch module further includes a second substrate provided on a surface opposite to a surface of the second optical clear adhesive on which the touch sensing portion is provided.

5. The touchscreen panel of claim 2, wherein the first and second optical clear adhesives are transparent.

6. The touchscreen panel of claim 1, wherein the sealing part is formed of a plastic material, and the plastic material has a random recrystallized structure.

7. The touchscreen panel of claim 1, wherein the touch sensing portion is provided integrally with the first substrate.

8. A manufacturing method of a touchscreen panel, the manufacturing method comprising:
a first step of providing a touch module in which a first substrate, a touch sensing portion, and a second optical clear adhesive are sequentially laminated; and
a second step of forming a sealing part by supersonic-fusion or heat-fusion between edges of the second optical clear adhesive and the first substrate via a protective film remaining at an edge of the second optical clear adhesive.

9. The manufacturing method of claim 8, wherein in a process of adhering the second optical clear adhesive to the touch sensing portion, the first step includes a 1-2nd step of retaining protective film on a portion of the second optical clear adhesive protruding outwardly of an edge of the touch sensing portion and only removing the protective film from a portion of the second optical clear adhesive overlapped with the touch sensing portion in a lamination direction.

10. The manufacturing method of claim 8, wherein the first step includes a step of interposing a first optical clear adhesive between the first substrate and the touch sensing portion.

11. The manufacturing method of claim 10, wherein the first substrate and the second optical clear adhesive are provided so as to have areas larger than those of the touch sensing portion and the first optical clear adhesive to thereby protrude outwardly of edges of the touch sensing portion and the first optical clear adhesive.

12. The manufacturing method of claim 8, further comprising a third step of additionally laminating a second substrate on a surface thereof opposite to a surface of the second optical clear adhesive on which the touch sensing portion is provided.

13. The manufacturing method of claim 8, wherein the sealing part is formed of a plastic material, and a structure of the plastic material is deformed from a molecular oriented crystalline structure into a random recrystallized structure by the supersonic-fusion or heat-fusion.

14. The manufacturing method of claim 10, wherein the first and second optical clear adhesives are transparent.

15. The manufacturing method of claim 8, wherein the touch sensing portion is provided integrally with the first substrate.
